(19) United States
(12) Patent Application Publication
(10) Pub. No.: US 2025/0037257 A1
(43) Pub. Date: Jan. 30, 2025

(54) STATE DETECTION SYSTEM AND STATE DETECTION METHOD

(71) Applicant: Hitachi, Ltd., Tokyo (JP)

(72) Inventors: Takashi OSHIMA, Tokyo (JP); Keisuke Yamamoto, Tokyo (JP); Goichi Ono, Tokyo (JP); Keita Yamane, Tokyo (JP); Seiji Miura, Tokyo (JP)

(21) Appl. No.: 18/601,255

(22) Filed: Mar. 11, 2024

(30) Foreign Application Priority Data
Jul. 27, 2023 (JP) 2023-122196

(51) Int. Cl. G06T 7/00; G06F 18/241

(52) U.S. Cl. CPC G06T 7/0002; G06F 18/241; G06T 2207/20081; G06T 2207/20084; G06T 2207/30184

(57) ABSTRACT

A state detection system includes a computation unit that acquires data detected by a sensor. The computation unit includes a processing device that executes data processing. The processing device converts data of a digitized time-series signal from a sensor, into data on frequency spectrum intensity. The processing device converts a partial area in an overall area in which values of data on frequency spectrum intensity are distributed, into data expressed in low bits. The processing device generates a pseudo image, based on the data expressed in low bits. The processing device classifies the pseudo image, based on image recognition, and outputs a result of classification of a state of a facility.

### BACKGROUND OF THE INVENTION

### 1. Field of the Invention

The present invention relates to a state detection system and a state detection method.

### 2. Description of the Related Art

As aging of infrastructure facilities and plant facilities goes on, maintenance/management of the infrastructure facilities and plant facilities becomes an important social problem. This has led to a higher demand for an automatic facility monitoring technique. In recent years, a system that detects a problem with the appearance of a facility (scratches, cracks, etc.) by executing an AI-based image recognition process on images captured by cameras or satellite equipment has been put into practical use.

However, a method totally depending on images poses a problem that a detection ability is limited by image resolution restrictions and that only the problem with the appearance can be detected. As a solution to such a problem, there is a demand for a technique according to which a state of a facility can be detected with high accuracy and reliability by analyzing time-series signals from various sensors added to the facility or arranged near the facility.

However, analyzing time-series signals usually requires that a dedicated analysis algorithm be manually devised in accordance with types of sensors, characteristics of signals, types of states to be detected, and the like. It is thus not easy to build an intended system in a short period at low cost.

Meanwhile, an approach of identifying a state by processing time-series signals from sensors through an AI technology, such as deep learning, is also known. Generally speaking, however, deep learning capable of handling time-series signals involves a neural network that is difficult to train, thus requiring much time and efforts, which is a problem.

JP 2020-144619 A discloses a technique according to which time-series signals from sensors are arranged and converted into a pseudo RGB image, and this pseudo RGB image is analyzed by an image recognition AI using a convolutional neural network and a support vector machine to detect a problem with a facility. The convolutional neural network extracts a feature from the above RGB image, and the support vector machine determines whether a problem exists (binary determination), based on the extracted feature.

The technique of JP 2020-144619 A replaces a problem included in a time-series signal with a problem included in an image, thereby allowing application of the image recognition AI that is trained easily. However, in the case of a vibration sensor, etc., phases (time delays) of sensor signals and phase differences (time differences) between sensor signals may vary in an infinite number of patterns, so that images, into which the signals are converted, vary in an infinite number of patterns as well. This creates a new challenge in ensuring learning accuracy and inference accuracy.

In addition, promoting widespread use of a state detection system in actual fields requires that the state detection system be built based on a low-cost edge device with limited hardware resources.

### SUMMARY OF THE INVENTION

The progress of A/D conversion circuit technology, etc., in recent years affords sensor signals with high resolution. To incorporate the image recognition AI into the edge device, however, the expression word length (resolution) of an image needs to be reduced. This creates another problem that the high resolution of sensor signals cannot be fully utilized.

In view of the above circumstances, an object of the present invention is to provide a state detection system or the like that is applied to an edge device and that allows detection of a state of a facility, the detection being based on a sensor, by utilizing the high resolution of a sensor signal without being affected by a phase of the sensor signal.

According to a first aspect of the present invention, the following state detection system is provided. The state detection system includes a computation unit that acquires data detected by a sensor. The computation unit includes a processing device that executes data processing. The processing device converts data of a digitized time-series signal from a sensor, into data on frequency spectrum intensity. The processing device converts a partial area in an overall area in which values of data on frequency spectrum intensity are distributed, into data expressed in low bits. Based on the data expressed in low bits, the processing device generates a pseudo image. Based on image recognition, the processing device classifies a pseudo image, and outputs a result of classification of a state of a facility.

According to a second aspect of the present invention, the following state detection method is provided. The method includes a processing device's converting data of a digitized time-series signal from a sensor, into data on frequency spectrum intensity, the processor executing data processing. The method further includes the processing device's converting a partial area in an entire area in which values of data on frequency spectrum intensity are distributed, into data expressed in low bits. The method further includes the processing device's generating a pseudo image, based on the data expressed in low bits. The method further includes the processing device's classifying a pseudo image, based on an image recognition result, and outputting a result of classification of a state of a facility.

The present invention provides a state detection system or the like that is applied to an edge device and that allows detection of a state of a facility, the detection being based on a sensor, by utilizing high resolution of a sensor signal without being affected by a phase of the sensor signal. Problems, configurations, and effects that are not described above will be made clear by the following description of preferred embodiments.

### BRIEF DESCRIPTION OF THE DRAWINGS

FIG. 1 depicts a configuration example of a state detection system according to a first embodiment;

FIG. 2 an explanatory diagram of an example of a pseudo image generation process according to the first embodiment;

FIG. 3A is an explanatory diagram of an operation example in a case where range shifting is applied;

FIG. 3B is an explanatory diagram of an operation example in a case where range shifting is not applied;

FIG. 4A is an explanatory diagram of an example of an operation related to range shifting;

FIG. 4B depicts a configuration example of a range shifting unit;

FIG. 5A depicts a configuration example of a state detection system according to a second embodiment;

FIG. 5B depicts an example of an operation in the second embodiment, showing a diagram for explaining search for an optimal partial area;

FIG. 6 depicts a configuration example of a state detection system according to a third embodiment;

FIG. 7 depicts a configuration example of a state detection system according to a fourth embodiment;

FIG. 8A depicts a configuration example of a state detection system according to a fifth embodiment;

FIG. 8B is an explanatory diagram of an operation example in which range compression shifting is applied;

FIG. 8C depicts a configuration example of a range compressing/shifting unit;

FIG. 9A depicts a configuration example of a state detection system according to a sixth embodiment;

FIG. 9B is an explanatory diagram of an operation example in which range shifting is applied;

FIG. 10 is an explanatory diagram of a seventh embodiment;

FIG. 11A is an explanatory diagram of an eighth embodiment;

FIG. 11B is an explanatory diagram of the eighth embodiment;

FIG. 11C is an explanatory diagram of the eighth embodiment;

FIG. 12 depicts an example of a hardware configuration of the state detection system;

FIG. 13 depicts an example of a hardware configuration of the state detection system; and

FIG. 14 depicts an example of a hardware configuration of the state detection system.

### DESCRIPTION OF THE PREFERRED EMBODIMENTS

Embodiments of the present invention will hereinafter be described with reference to the drawings. The embodiments are exemplary one for explaining the present invention, and description of the embodiments involves omission and simplification, when necessary, to make the description clear. The present invention may also be implemented in various forms other than the embodiments.

When a plurality of constituent elements that are entirely identical or identical in function with each other are present, such constituent elements may be denoted by the same reference sign with different subscripts attached thereto. When distinguishing these constituent elements from each other is unnecessary, however, the constituent elements may be described with the subscripts omitted therefrom.

In the embodiments, a process executed by running a program may be described. In such a case, a computer runs a program by a processor (e.g., a CPU or GPU), and executes a process defined by the program, using a storage resource (e.g., a memory), an interface device (e.g., a communication port), and the like. A main component that executes the process by running the program, therefore, may be considered to be the processor. Similarly, the main component responsible for executing the process by running the program may be considered to be a controller, a device, a system, a computer, or a node having the processor.

A program may be acquired from a program source and installed in the computer. The program source may be, for example, a program distribution server or a computer-readable recording medium. When the program source is a program distribution server, the program distribution server may include a processor and a storage resource that stores a program to be distributed, and the processor of the program distribution server may distribute the program to be distributed, to a different computer. In the embodiments, two or more programs may be implemented as one program or one program may be implemented as two or more programs.

### First Embodiment

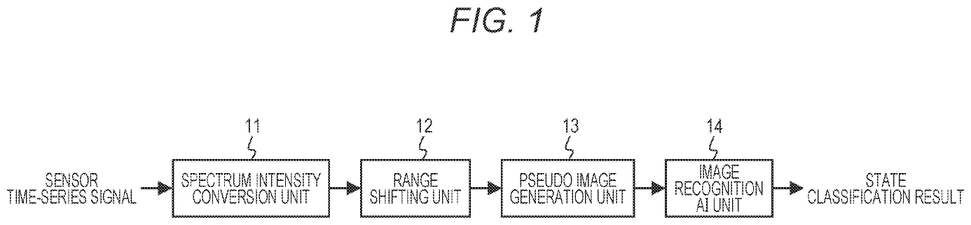

The present invention relates to a technique of automatically detecting a state of a facility or the like from a sensor signal, and is applied to, for example, maintenance/management of an infrastructure facility, thus providing solutions to social problems. The present invention allows image-recognition-based state detection that is not affected by a phase of a sensor signal and that is suitable for automatization and hardware weight reduction. FIG. 1 depicts a configuration example of a state detection system according to a first embodiment of the present invention. To monitor the state of a facility, one or more sensors are arranged on the facility or in the vicinity of the facility. It is assumed that a time-series signal outputted from each sensor is already digitized at the point of being outputted from the sensor or is digitized by an A/D converter disposed in a rear stage to the sensor. The digitized time-series signal (hereinafter, “sensor time-series signal”) is inputted to a spectrum intensity conversion unit 11.

The spectrum intensity conversion unit 11 converts the sensor time-series signal into a vector on frequency spectrum intensity through, for example, discrete Fourier transform, fast Fourier transform (FFT), or the like. Specifically, the spectrum intensity conversion unit 11 converts the signal into information on a complex component I+j*Q at each frequency position through discrete Fourier transform, FFT, or the like and then obtains a spectrum intensity from the complex component by performing a calculation, such as √(I²+Q²). A window function may be applied when discrete Fourier transform or fast Fourier transform is executed, as is in general cases. In this manner, spectrum intensities at respective frequency positions are obtained as a spectrum intensity vector. The spectrum intensity conversion unit 11 outputs such spectrum intensity vectors of which the number matches the number of sensors.

Each of the spectrum intensity vectors is inputted to a range shifting unit 12. The range shifting unit 12 reduces the expression word length of the value of each element of the spectrum intensity vector (i.e., the value of each frequency spectrum intensity) to, an 8-bit length, which is equal to the expression word length of a pseudo image to be described later, and outputs the spectrum intensity vector. As a result, the spectrum intensity vectors expressed in low bits are outputted as the spectrum intensity vectors of which the number matches the number of sensors.

Each of the spectrum intensity vectors expressed in low bits is inputted to a pseudo image generation unit 13. The pseudo image generation unit 13 treats one spectrum intensity vector expressed in low bits, as one line, and vertically lines up the spectrum intensity vectors expressed in low bits that correspond respectively to the sensors, thereby generating a two-dimensional image. The generated image is not a normal image like a camera image, but is a pseudo image. The expression word length of this pseudo image is equal to the expression word length of the frequency spectrum intensity value, the expression word length being reduced by the range shifting unit 12. In this manner, the expression word length of the pseudo image is reduced. This significantly reduces the amount of calculations an image recognition AI unit 14 needs to perform, thus allowing the image recognition AI unit 14 to be incorporated in an edge device with limited hardware resources.

The pseudo image is inputted to the image recognition AI unit 14. The image recognition AI unit 14 is, for example, a convolutional neural network. The image recognition AI unit 14 regards the pseudo image as a normal image, classifying the image and outputting a classification result. Hence a result of classification of the state of the facility monitored by the sensor (e.g., a first normal state, a second normal state, a first abnormal state, a second abnormal state, a third abnormal state, and the like) is obtained. It should be noted that the convolutional neural network learns models in advance, the models being trained using pseudo images corresponding to these states.

The image recognition AI unit 14 may be a neural network different from the convolutional neural network or may execute a machine learning algorithm different from an algorithm adopted by the neural network. In such a case, the neural network learns models in advance and then classify images in the same manner as described above.

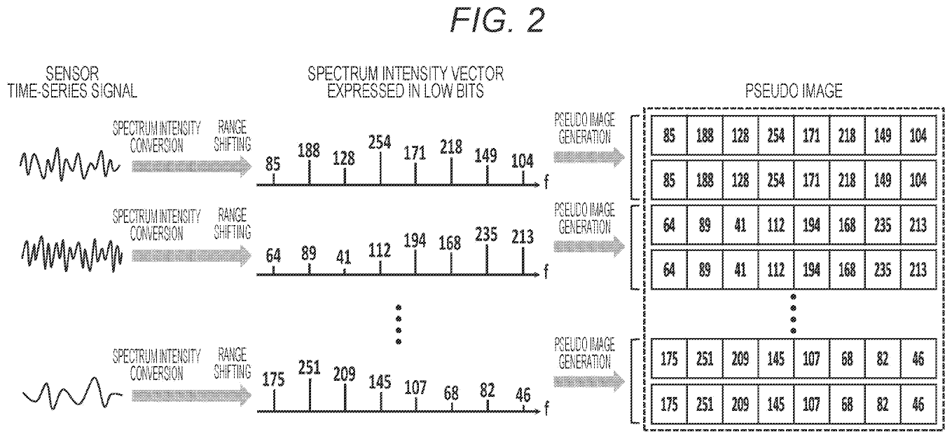

This embodiment will be described more specifically with reference to FIG. 2. As described above, subjecting each sensor time-series signal to discrete Fourier transform or fast Fourier transform (FFT) produces a spectrum intensity vector. The spectrum intensity vector is data on frequency spectrum intensity values at respective frequency positions that are laterally lined up. The number of dimensions (i.e., the number of frequency positions) of the vector is equal to the half of the number of sampling points in discrete Fourier transform or fast Fourier transform. FIG. 2 shows a case where the number of sampling points in the transform is 16 and the number of dimensions of the vector is 8. Any given number of sampling points, however, may be chosen on a necessary basis.

According to the number of sampling points in the transform, a time span of the sensor signal that is used at every pseudo image generation is determined. Specifically, this time span is equal to the product of a time interval of the sensor time-series signal and the number of sampling points. Frequency resolution (each interval between frequency positions) is equal to the reciprocal of the time span.

FIG. 2 shows a spectrum intensity vector that results when the range shifting unit 12 reduces the expression word length to 8 bits. Being expressed in 8 bits, the spectrum intensity vector is represented by integer values ranging from 0 to 255. In FIG. 2, a spectrum intensity vector expressed in low bits (8 bits) that corresponds to a first sensor is represented as (85, 188, 128, 254, 171, 218, 149, 104). A spectrum intensity vector expressed in low bits (8 bits) that corresponds to a second sensor is represented as (64, 89, 41, 112, 194, 168, 235, 213).

When generating a pseudo image, the pseudo image generation unit 13 treats a spectrum intensity vector expressed in low bits, as one row and vertically lines up such lows of spectrum intensity vectors. In this process, as shown in FIG. 2, a plurality of rows of spectrum intensity vectors expressed in low bits that correspond to one sensor may be lined up repeatedly. In FIG. 2, a set of two lows of spectrum intensity vectors are lined up repeatedly. Specifically, the spectrum intensity vector expressed in low bits that corresponds to the first sensor is lined up in the first and second rows in the pseudo image, and the spectrum intensity vector expressed in low bits that corresponds to the second sensor is lined up in the third and fourth rows. The rest of spectrum intensity vectors are then lined up in the same manner to complete the pseudo image.

The size of the lateral width (the number of pixels) of the pseudo image generated by the above process is equal to the number of dimensions of the spectrum intensity vector expressed in low bits (which is 8 pixels in FIG. 2). The size of the vertical width (the number of pixels), on the other hand, is equal to the product of the number of sensors and the number of rows repeatedly lined up for each sensor.

The number of sampling points in the above discrete Fourier transform or fast Fourier transform may be, for example, 32. In this case, the number of dimensions of each spectrum intensity vector is 16. When the lateral width of the pseudo image needs to be set to, for example, eight pixels, therefore, each spectrum intensity vector is divided into two spectrum intensity subvectors with eight dimensions (a first spectrum intensity subvector and a second spectrum intensity subvector), and each of them is used as one row of the pseudo image. This approach may be combined with the above repetitive lining up of lows.

For example, the first spectrum intensity subvector corresponding to the first sensor is located in the first row of the pseudo image and is repeatedly located in the second row as well, the second spectrum intensity subvector corresponding to the first sensor is located in the third row and is repeatedly located in the fourth row as well, the first spectrum intensity subvector corresponding to the second sensor is located in the fifth row and is repeatedly located in the sixth row as well, and the second spectrum intensity subvector corresponding to the second sensor is located in the seventh row and is repeatedly located in the eighth row as well. Hence the pseudo image composed of 8×8 pixels is generated out of data from two sensors.

Spectrum intensity subvectors may be arranged in a different manner. For example, the first spectrum intensity subvector corresponding to the first sensor is located in the first row of the pseudo image and is repeatedly located in the second row as well, the first spectrum intensity subvector corresponding to the second sensor is located in the third row and is repeatedly located in the fourth row as well, the second spectrum intensity subvector corresponding to the first sensor is located in the fifth row and is repeatedly located in the sixth row as well, and the second spectrum intensity subvector corresponding to the second sensor is located in the seventh row and is repeatedly located in the eighth row as well. Hence the pseudo image composed of 8×8 pixels is generated out of data from two sensors. A pseudo image of a size different from the 8×8-pixel size may be generated. Repetitive lining up of lows and spectrum intensity vector division described above allows generation of pseudo images of various sizes. The number of times of repetition and the number of divided spectrum intensity vectors, i.e., spectrum intensity subvectors can be properly selected according to the required size of the pseudo image. The number of times of repetition may be 1, which means no repetitive lining up of rows.

As described above, the pixel values of the pseudo image are frequency spectrum intensities expressed in low bits, and are therefore not affected by phases of sensor time-series signals. This facilitates a learning process at the image recognition AI unit 14 and improves inference accuracy as well.

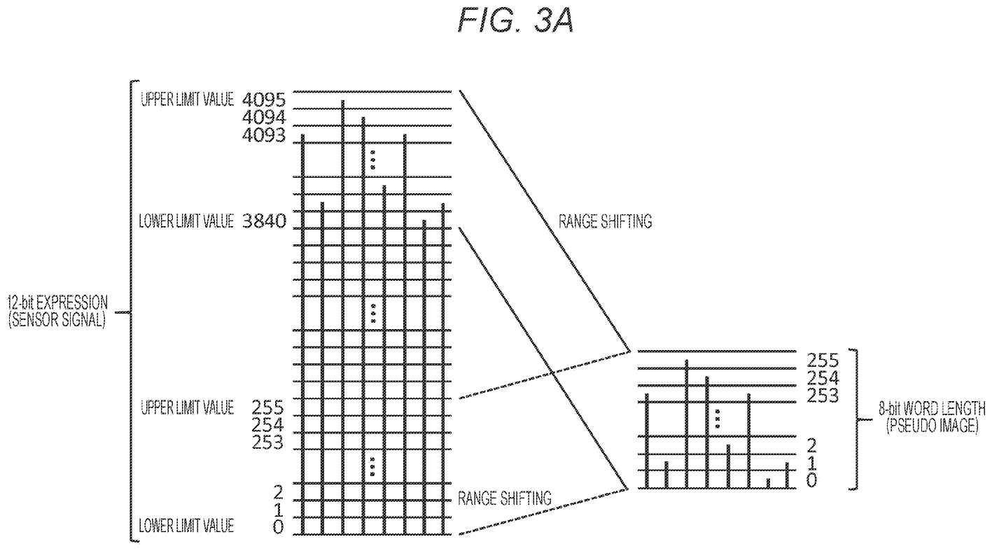

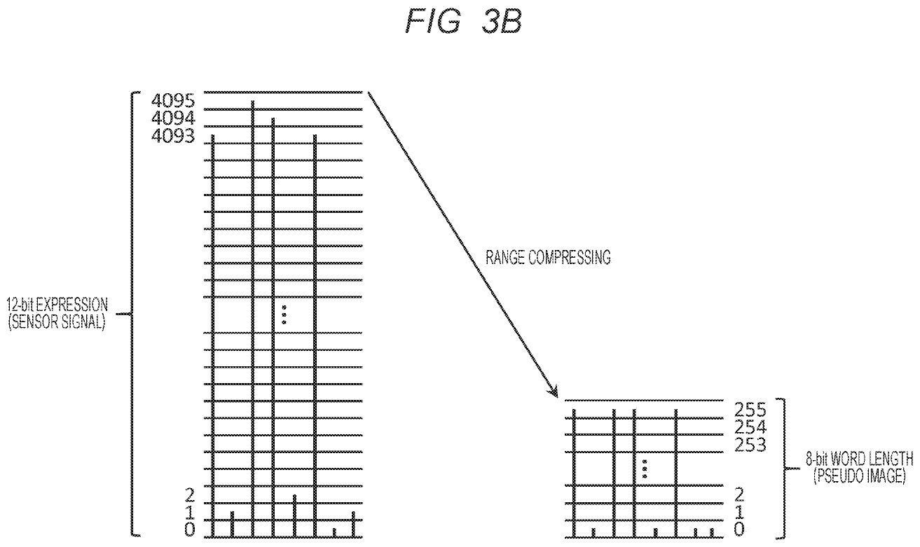

An operation of the range shifting unit 12 will be described more specifically with reference to FIG. 3A. In many cases, the noise level of a sensor itself is sufficiently low and the effective resolution of an A/D converter that digitizes the output of the sensor is sufficiently high. For this reason, an output value (i.e., frequency spectrum intensity at each frequency position) from the spectrum intensity conversion unit 11 is expressed in high bits. For example, in FIG. 3A, the output value has a word length of 12 bits, which takes 4096 (=212) values ranging from 0 to 4095. In contrast, to reduce a calculation load of the image recognition AI unit 14, the expression word length of the pseudo image is reduced to, for example, 8 bits in FIG. 3A. The word length of 8 bits takes only 256 (=28) values ranging from 0 to 255. To deal with this problem, the range shifting unit 12 pays attention to a partial area with a 256-range in an area with a 4096-range (0 to 4095) where frequency spectrum intensity values of a sensor signal are present, and expresses frequency spectrum intensity values present in the partial area in 8 bits (0 to 255). For example, in FIG. 3A, the range shifting unit 12 pays attention to a partial area (3840 to 4095) at the uppermost part and expresses frequency spectrum intensity values present in the partial area in 8 bits by converting 12-bit expression into 8-bit expression. Specifically, the conversion is made by subtracting a lower limit value of the partial area paid attention to (which is 3840 in FIG. 3A) from each frequency spectrum intensity value.

As indicated by broken lines in FIG. 3A, the partial area paid attention to may be changed. The broken lines in FIG. 3A indicate a partial area (0 to 255) located at the lowermost part. It should be noted that in FIG. 3A, frequency spectrum intensities at eight frequency positions included in one spectrum intensity vector are indicated, and these frequency spectrum intensities are converted into frequency spectrum intensities with an 8-bit word length, as shown in FIG. 3A, and are used as one row in the pseudo image.

In the above description, the conversion into the 8-bit word length is made based on the lower limit value of the partial area. This conversion, however, may be made based on any given reference value indicating the partial area. For example, an upper limit value of the partial area may be used as the reference value or a center position or any given position in the partial area may also be used as the reference value.

FIG. 3B shows an example in which range shifting is not applied. Similar to the case of FIG. 3A, frequency spectrum intensity at each frequency position is expressed as 12-bit word length data, which takes values ranging from 0 to 4095. The pseudo image has an expression word length of 8 bits, which takes only the values ranging from 0 to 255. In FIG. 3B, conversion from the 12-bit expression into the 8-bit expression is made by range compression. Specifically, 4080 to 4095 in the 12-bit expression are converted into 255 in the 8-bit expression. 4064 to 4079 in the 12-bit expression are converted into 254 in the 8-bit expression, and 4048 to 4063 in the 12-bit expression is converted into 253 in the 8-bit expression. In the same manner, other groups of 16 consecutive values in the 12-bit expression are each converted into one value in the 8-bit expression, and finally, 0 to 15 in the 12-bit expression are converted into 0 in the 8-bit expression.

The spectrum intensity vector of the sensor signal in FIG. 3B is the same as that in FIG. 3A. However, because of the above range compression, four frequency spectrum intensity values near the upper limit of the range are all rounded down to 255. Likewise, four frequency spectrum intensity values near the lower limit of the range are all rounded down to zero. In this manner, applying the range compression results in a drop in the resolution of the pseudo image, which resolution turns out to be lower than the original resolution of the sensor signal. As a result, a slight change appearing in the sensor signal is not reflected in the pseudo image, in which case the image recognition AI is unable to identify the slight change. Sensitivity in detecting the state of the facility, therefore, drops.

In contrast, the range shifting of the present invention (FIG. 3A) does not give rise to a rounding error at the conversion into 8-bit expression. This is because that the range shifting does not convert the whole area into the pseudo image but cuts out the partial area equal in size to an 8-bit expression area (256 values) and converts the cuts out the partial area into the pseudo image. According to the range shifting of this embodiment, therefore, a slight change appearing in the sensor signal appears in the pseudo image as a corresponding change, which allows the image recognition AI to identify the slight change. Sensitivity in detecting the state of the facility is thus improved.

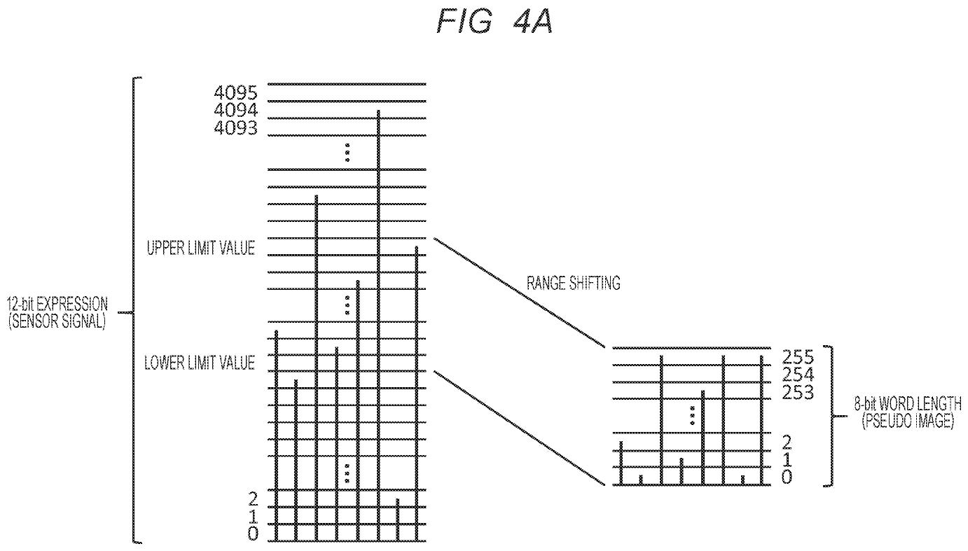

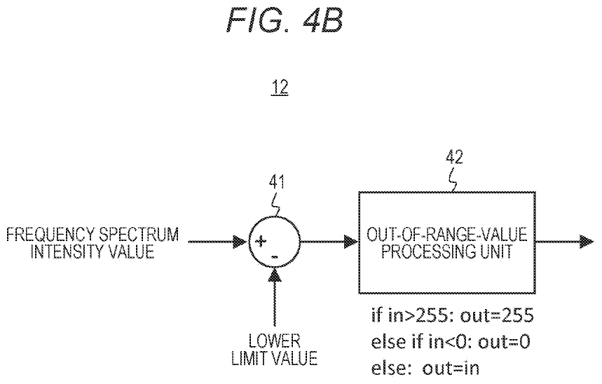

The operation of the range shifting unit 12 will be further described in detail with reference to FIG. 4. FIG. 4A shows a method of handling frequency spectrum intensity values presenting outside a partial area paid attention to. In FIG. 4A, frequency spectrum intensity values exceeding frequency spectrum intensity values in the partial area paid attention to are converted into a first fixed value (255 in FIG. 4A) at the conversion into the 8-bit expression. Frequency spectrum intensity values smaller than the frequency spectrum intensity values in the partial area paid attention to are converted into a second fixed value (0 in FIG. 4A) at the conversion into the 8-bit expression. As a result, frequency spectrum intensities outside the partial area paid attention to are not reflected on the pseudo image even if values of the frequency spectrum intensities change. Thus, only the changes in the frequency spectrum intensities in the partial area paid attention to can be reflected on the pseudo image. This improves the accuracy of the learning process at the image recognition AI unit 14 and the accuracy of inference as well.

To implement the above operation, the range shifting unit 12 includes a subtractor 41 and an out-of-range-value processing unit 42 at a rear stage to the subtractor 41, as shown in FIG. 4B. Each frequency spectrum intensity value is inputted to the subtractor 41, where, as mentioned above, the lower limit value of the partial area paid attention to is subtracted from the frequency spectrum intensity value. Thus, when the frequency spectrum intensity value is present in the partial area paid attention to, the subtraction result is given as a value of 0 or larger and 255 or smaller. When the frequency spectrum intensity value exceeds the frequency spectrum intensity value in the partial area paid attention to, on the other hand, the subtraction result is a value larger than 255. When the frequency spectrum intensity value is smaller than the frequency spectrum intensity value in the partial area paid attention to, the subtraction result is a value smaller than 0.

The out-of-range-value processing unit 42 at the rear stage to the subtractor 41 outputs the first fixed value (255 in FIG. 4A) when the incoming subtraction result is larger than 255, and outputs the second fixed value (0 in FIG. 4A) when the incoming subtraction result is smaller than 0. When the incoming subtraction result is 0 or larger and 255 or smaller, the out-of-range-value processing unit 42 outputs the subtraction result in its original state. In this manner, the above operation is implemented. The first fixed value may be a value different from 255 (that is, 0 to 254), and the second fixed value may be a value different from 0 (that is, 1 to 255).

In the above description, the lower limit value of the partial area is subtracted. Any given reference value indicating the partial area, however, may be subtracted. For example, when the upper limit value of the partial area is subtracted, the frequency spectrum intensity value in the partial area is converted into a value ranging from −255 to 0. A frequency spectrum intensity value exceeding the frequency spectrum intensity value in the partial area is converted into a value of 1 or larger, and a frequency spectrum intensity value smaller than the frequency spectrum intensity value in the partial area is converted into a value of −256 or smaller. In the latter case, the sign of the subtraction result is reversed (that is, the subtraction result is multiplied by −1) and then the subtraction result is inputted to the out-of-range-value processing unit 42 where the subtraction result is subjected to the above process.

In this manner, the main operation of the invention does not change no matter what reference value indicating the partial area is selected. Therefore, in the following description of the embodiment, only the case where the lower limit value is selected as reference value will be described.

In the above description, the case where the expression word length of the frequency spectrum intensity of the sensor signal is 12 bits and the expression word length of the pseudo image is 8 bits has been described as an exemplary case. The present invention, however, apply similarly to cases where expression word lengths different from the above expression word lengths are adopted.

Respective operations of the spectrum intensity conversion unit 11, the range shifting unit 12, the pseudo image generation unit 13, and the image recognition AI unit 14 may be executed by using an accelerator (dedicated hardware) or may be executed by software processing using a general-purpose processor, such as a CPU. An internal memory (SRAM, etc.) built in an accelerator chip or a CPU chip may be used or an external memory (DRAM, etc.) may also be used.

As described above, according to this embodiment, the state of the facility can be classified with high reliability without being affected by the phase of the sensor time-series signal. In addition, the high resolution of the sensor signal can be utilized even if an edge device is applied. A slight difference in the state, therefore, can be classified. Hence a facility state detection system to which the edge device is applied, the system offering advantages of low-cost, high reliability, and high sensitivity, is provided.

### Second Embodiment

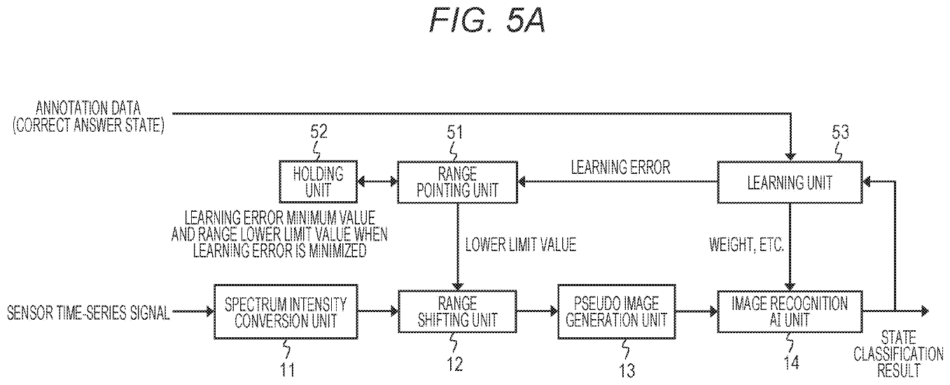

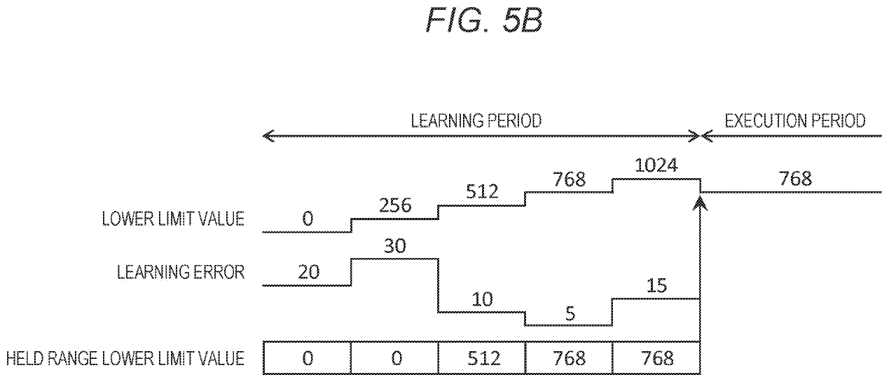

A configuration of a state detection system according to a second embodiment of the present invention is shown in FIG. 5A. As described above, according to the present invention, a proper partial area needs to be cut out from a wide area of frequency spectrum intensities of a sensor signal. To meet this requirement, this embodiment provides a method of searching for an optimal partial area, based on a learning result of an image recognition AI. It should be noted that description of the same content as already described above may be omitted.

As shown in FIG. 5A, in the same manner as in the first embodiment, a sensor time-series signal is sequentially processed by the spectrum intensity conversion unit 11, the range shifting unit 12, the pseudo image generation unit 13, and the image recognition AI unit 14. In this embodiment, the state detection system further includes a range pointing unit 51, a holding unit 52, and a learning unit 53. An operation timing chart of this embodiment is shown in FIG. 5B. The range pointing unit 51 sequentially points to the range shifting unit 12 lower limit values of partial areas to pay attention to.

For example, in FIG. 5B, the range pointing unit 51 sequentially points 0, 256, 512, 768, and 1024 as the lower limit values. As a result, in the same manner as in the first embodiment, the range shifting unit 12 sequentially pays attention to partial areas of 0 to 255, 256 to 511, 512 to 767, 768 to 1023, and 1024 to 1279 and converts the partial areas into areas with the 8-bit expression word length. Based on each spectrum intensity vector converted into a spectrum intensity vector with the 8-bit expression word length by the range shifting unit 12, the pseudo image generation unit 13 generates a pseudo image, as does in the first embodiment.

In a state in which the above lower limit values are each pointed, a sensor time-series signal for training is inputted to the spectrum intensity conversion unit 11 as the corresponding annotation data (correct answer state) is inputted to the learning unit 53. For example, a sensor time-series signal acquired in advance in state 1, state 2, etc., of the facility is inputted to the spectrum intensity conversion unit 11, and a correct answer state, such as “state 1” and “state 2”, is inputted to the learning unit 53, as the corresponding annotation data. As a result, in a state in which attention is paid to each partial area, a pseudo image corresponding to the state 1, the state 2, etc., is generated in the above manner and is supplied to the image recognition AI unit 14.

The image recognition AI unit 14 is, for example, a convolutional neural network, classifying the supplied pseudo image and outputting a state classification result. The state classification result is given in the form of, for example, a probability, such as 70% probability of being state 1 and 30% probability being state 2. The state classification result is supplied to the learning unit 53. The learning unit 53 compares the supplied annotation data (correct answer state, such as “state 1” and “state 2”) with the state classification result, updates a parameter, such as a weight, based on a difference between the annotation data and the state classification result, and supplies the updated parameter to the convolutional neural network.

In the above state in which each lower limit value is pointed (i.e., the state in which attention is paid to each partial area), updating of a parameter, such as a weight, by the above operation is repeatedly carried out on annotation data corresponding to many sensor time-series signals for training. After parameter updating converges to a final parameter, the learning unit 53 calculates a learning error, based on the difference between the state classification result and the annotation data. The learning error is transmitted to the range pointing unit 51, which points to the holding unit 52 a value to hold, based on the learning error.

In FIG. 5B, the learning error is 20 in a state where the lower limit value is 0 (attention is paid to the partial area of 0 to 255), and the learning error increases to 30 in a state where the lower limit value is set to 256 (attention is paid to the partial area of 256 to 511). The holding unit 52 stores a learning error minimum at the present point and a lower limit value corresponding thereto. First, the holding unit 52 stores 0, which is the first lower limit value, and 20, which is a learning error corresponding to the lower limit value. In the following state where the lower limit value is 256, the learning error increases to 30. The holding unit 52 thus maintains what it is currently holding. As shown in FIG. 5B, in the following state where the lower limit value is 512 (attention is paid to the partial area of 512 to 767), the learning error decreases to 10, which is smaller than the held learning error value of 20. The holding unit 52 thus updates the currently held values, holding 10 as the learning error and 512 as the corresponding lower limit value. In the following state where the lower limit value is 768 (attention is paid to the partial area of 768 to 1023), the learning error decreases to 5, which is smaller than the held learning error value of 10. The holding unit 52 thus updates the held values, holding 5 as the learning error and 768 as the corresponding lower limit value. Finally, in a state where the lower limit value is 1024 (attention is paid to the partial area of 1024 to 1279), the learning error is increases to 15, which is larger than the held learning error value of 5. The holding unit 52 thus maintains the held values. At this point, a learning period comes to an end, and the holding unit 52 finally holds the lower limit value of 768 corresponding to the learning error minimum.

Following the end of the learning period, a period for executing detection of the state of the facility starts. Before execution of the detection, the image recognition AI unit 14 relearns parameters, such as a weight parameter, for the convolutional neural network. For this parameter learning, a sensor time-series signal for training is inputted to the spectrum intensity conversion unit 11, and annotation data corresponding to the signal is inputted to the learning unit 53. The range pointing unit 51 points 768 to the range shifting unit 12, 768 being the lower limit value (the lower limit value that minimizes the learning error) retrieved in the learning period, as the lower limit value of the optimal partial area.

As a result, as described above, a pseudo image is generated as attention is paid to the partial area (the partial area of 768 to 1023) corresponding to the lower limit value of 768, and a state classification result is obtained from the convolutional neural network. As described above, the learning unit 53 repeatedly updates a parameter, such as a weight, based on the state classification result and annotation data. After the updating converges to a final parameter, the convolutional neural network holds a parameter, such as a final weight, and becomes ready for executing the state detection.

Then, an actual sensor time-series signal (not a signal for training) is inputted to the spectrum intensity conversion unit 11, and based on the actual sensor time-series signal, a pseudo image with attention paid to the optimal partial area (the partial area of 768 to 1023 in this case) is generated and is classified by the convolutional neural network. The convolutional neural network outputs a state classification result in the above-described manner. This makes it possible to know the probability of the target facilities' being in each of various states.

It should be noted that, in the above description, the image recognition AI unit 14 may be a neural network different from the convolutional neural network, or may perform learning and inference using a machine learning algorithm different from an algorithm adopted by the neural network.

Respective operations of blocks in FIG. 5A may be carried out on the same edge device. It may also possible that the operation in the execution period of FIG. 5B is carried out on the edge device while the operation in the learning period is carried out on a different device with higher computation ability (e.g., an external computer like a server). In such a case, respective operations of the blocks in FIG. 5A are carried out on the different device, while the operations of the spectrum intensity conversion unit 11, the range shifting unit 12, the pseudo image generation unit 13, and the image recognition AI unit 14 are carried out on the edge device. The lower limit value of the optimal partial area and the parameter, such as the final weight, which are obtained through the operations on the different device in the learning period, are transmitted to the edge device before the start of the execution period. The different device may carry out only some of the operations shown in FIG. 5A.

According to this embodiment, an optimal partial area can be automatically retrieved from a wide area of frequency spectrum intensities of a sensor signal. Because of this advantage, the facility state detection system can be built easily.

### Third Embodiment

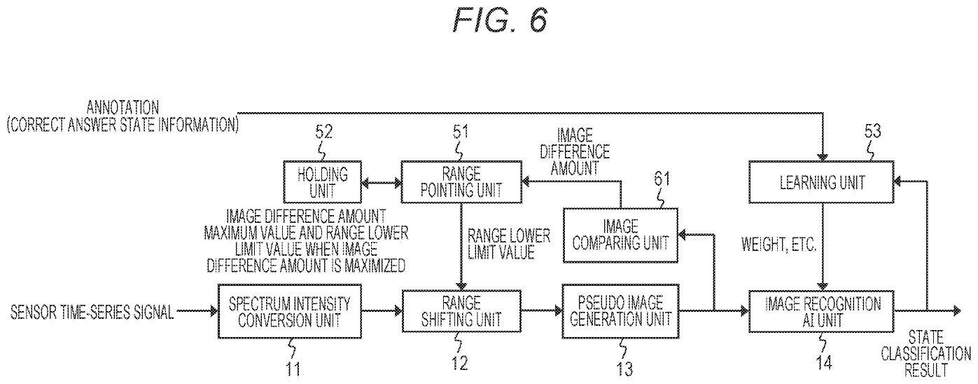

A third embodiment of the present invention will be described with reference to FIG. 6. It should be noted that description of the same content as already described above may be omitted. In the third embodiment, an optimal partial area is automatically retrieved, as is in the second embodiment. However, while the optimal partial area is retrieved based on a learning result from the image recognition AI unit in the second embodiment, the optimal partial area is retrieved through analysis of a pseudo image in the third embodiment.

As shown in FIG. 6, in the same manner as in the first embodiment, a sensor time-series signal is sequentially processed by the spectrum intensity conversion unit 11, the range shifting unit 12, the pseudo image generation unit 13, and the image recognition AI unit 14. In the same manner as in the second embodiment, the state detection system includes the range pointing unit 51, the holding unit 52, and the learning unit 53. In this embodiment, the state detection system further includes an image comparing unit 61.

The range pointing unit 51 sequentially points to the range shifting unit 12 lower limit values of partial areas to pay attention to. For example, the range pointing unit 51 sequentially points 0, 256, 512, 768, and 1024 as the lower limit values, in the same manner as shown in FIG. 5B. As a result, in the same manner as in the second embodiment, the range shifting unit 12 sequentially pays attention to partial areas of 0 to 255, 256 to 511, 512 to 767, 768 to 1023, and 1024 to 1279 and converts the partial areas into areas with the 8-bit expression word length. Based on each spectrum intensity vector converted into a spectrum intensity vector with the 8-bit expression word length by the range shifting unit 12, the pseudo image generation unit 13 generates a pseudo image, as does in the first embodiment.

In a state in which the above lower limit values are each pointed, a sensor time-series signal for training is inputted to the spectrum intensity conversion unit 11. For example, sensor time-series signals each acquired in advance in state 1, state 2, etc., of the facility are inputted to the spectrum intensity conversion unit 11. As a result, in a state in which attention is paid to each partial area, pseudo images each corresponding to the state 1, the state 2, etc., are generated by the pseudo image generation unit 13 in the above manner.

In this embodiment, the generated pseudo image is supplied also to the image comparing unit 61. For example, the image comparing unit 61 calculates an “image difference amount” between a pseudo image corresponding to the state 1 and a pseudo image corresponding to the state 2. The image difference amount is an index that quantitatively indicates a difference between two images, and is calculated by, for example, squaring a difference between respective pixel values of two images, the pixel values corresponding to respective pixels at the same position of the two images, and summing up those squared differences obtained for all pixels.

The image comparing unit 61 calculates the image difference amount between a pseudo image in averaged state 1 and a pseudo image in averaged state 2. The pseudo image in the averaged state 1 is obtained by calculating averages of respective pixels of a plurality of pseudo images corresponding to the state 1, and the pseudo image in the averaged state 2 is obtained by calculating averages of respective pixels of a plurality of pseudo images corresponding to the state 2. The image difference amount is transmitted to the range pointing unit 51, and the range pointing unit 51 points to the holding unit 52 a value to hold, based on the image difference amount.

It is expected that as an image difference amount between pseudo images in different states gets larger, classification by the image recognition AI unit 14 becomes easier and therefore classification accuracy becomes higher. For this reason, in this embodiment, a partial area that maximizes an image difference amount between pseudo images in different states is searched for.

In each state of the lower limit value being pointed, an image difference amount is obtained, as described above. First, the holding unit 52 holds 0, which is the first lower limit, and an image difference amount corresponding thereto. In the following state where the lower limit value is 256, when an image difference amount is larger than the currently held image difference amount (i.e., the image difference amount in the state where the lower limit value is 0), the holding unit 52 updates the held values, thus holding the updated image difference amount and 256, i.e., the lower limit value corresponding thereto. When an image difference amount is equal to or smaller than the currently held image difference amount, on the other hand, the holding unit 52 maintains the held values. In the following states of the lower limit value being pointed, in the same manner as described above, the held values are updated when an image difference amount is larger than the currently held image difference amount (which is the maximum of image difference amounts calculated in past range shifting), and are maintained when an image difference amount is not larger than the currently held image difference amount. As a result, after calculations are made for each lower limit value, the lower limit value that maximizes the image difference amount is held by the holding unit 52. At this point, the period for searching for the optimal partial area comes to an end.

Following the end of the period for searching for the optimum partial area, the period for executing detection of the state of the facility starts. The image recognition AI unit 14, which is, for example, the convolutional neural network, learns parameters, such as a weight parameter, before execution of the detection. For this parameter learning, a sensor time-series signal for training is inputted to the spectrum intensity conversion unit 11, and annotation data corresponding to the signal is inputted to the learning unit 53. The range pointing unit 51 points a lower limit value held by the holding unit 52 to the range shifting unit 12, the lower limit value maximizing the image difference amount, as the lower limit value of the optimal partial area.

As a result, a pseudo image is generated as attention is paid to the partial area, and a state classification result is obtained from the convolutional neural network. The learning unit 53 repeatedly updates a parameter, such as a weight, based on the state classification result and annotation data. After the updating converges to a final parameter, the convolutional neural network holds a parameter, such as a final weight, and becomes ready for executing the state detection.

Then, an actual sensor time-series signal (not a signal for training) is inputted to the spectrum intensity conversion unit 11, and based on the actual sensor time-series signal, a pseudo image with attention paid to the optimal partial area is generated and is classified by the convolutional neural network. The convolutional neural network outputs a state classification result in the above-described manner. This makes it possible to know the probability of the target facilities' being in each of various states.

It should be noted that, in the above description, the image recognition AI unit 14 may be a neural network different from the convolutional neural network, or may perform learning and inference using a machine learning algorithm different from an algorithm adopted by the neural network.

Respective operations of blocks in FIG. 6 may be carried out on the same edge device. It may also possible that the operation in the execution period is carried out on the edge device while searching for the optimal partial area and the image recognition AI's data learning are carried out on a different device with higher computation ability (e.g., an external computer like a server). In such a case, respective operations of the blocks in FIG. 6 are carried out on the different device, while the operations of the spectrum intensity conversion unit 11, the range shifting unit 12, the pseudo image generation unit 13, and the image recognition AI unit 14 are carried out on the edge device. The lower limit value of the optimal partial area and the parameter, such as the final weight, which are obtained through the operations on the different device, are transmitted to the edge device before the start of the execution period. The different device may carry out only some of the operations shown in FIG. 6

According to the third embodiment, in the same manner as in the second embodiment, an optimum partial area can be automatically retrieved from a wide area of frequency spectrum intensities of a sensor signal. Because of this advantage, the facility state detection system can be built easily.

In the second embodiment, the image recognition AI needs to carry out its learning process for each one of many partial areas (lower limit values). In the third embodiment, however, the image recognition AI carries out its learning process just once for the retrieved partial area without the need of extra learning. The learning period is therefore shortened. However, because the method of the third embodiment is different from the method of the second embodiment by which the partial area that actually minimizes the learning error is retrieved, there is a case where a learning error for a retrieved partial area is not the minimum learning error. Taking account of this fact leads to a conclusion that the third embodiment is considered to be preferable when priority is given to shortening of the learning period while the second embodiment is considered to be preferable when priority is given to the accuracy of classification of the state of the facility.

### Fourth Embodiment

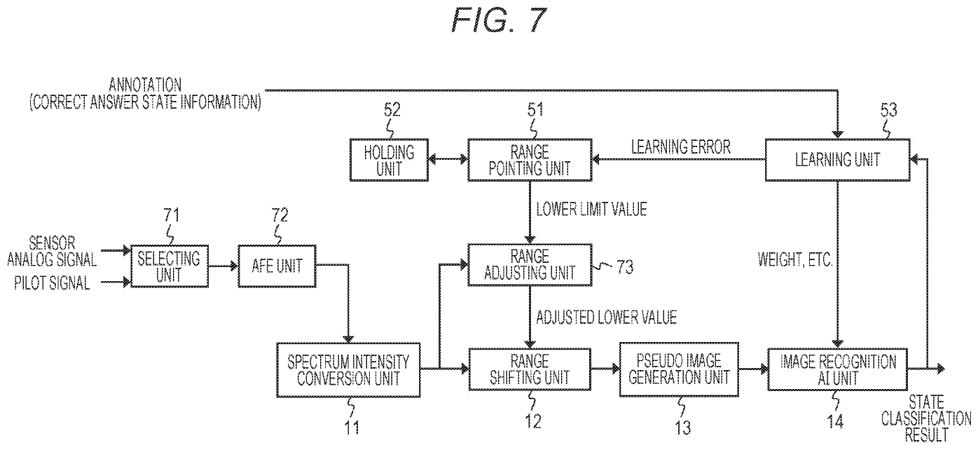

A fourth embodiment of the present invention will be described with reference to FIG. 7. It should be noted that description of the same content as already described above may be omitted. In the fourth embodiment, an analog signal (voltage signal, current signal, or the like) from a sensor is processed by an AFE unit (analog front end circuit) composed of, for example, an amplifier, a filter, an A/D converter, etc. The analog signal is converted by the A/D converter at the last stage in the AFE unit, into a digital sensor time-series signal.

As shown in FIG. 7, the analog signal from the sensor is inputted to a selecting unit 71. A pilot signal is inputted to the selecting unit 71 as well. One of these signals is selected by the selecting unit 71, and is inputted to the AFE unit 72, which carries out the above digitization of the incoming signal. Subsequently, the digital sensor time-series signal created by the AFE unit 72 is sequentially processed by the spectrum intensity conversion unit 11, the range shifting unit 12, the pseudo image generation unit 13, and the image recognition AI unit 14, in the same manner as in the above embodiments. In the same manner as in the second embodiment, the state detection system includes the range pointing unit 51, the holding unit 52, and the learning unit 53. In the same manner as in the second embodiment, in the learning period, the lower limit value of the optimal partial area is retrieved and then parameter relearning is carried out as attention is paid to the partial area, which puts the system ready for execution of detection of the state of the facility.

In this embodiment, a range adjusting unit 73 is disposed between the range pointing unit 51 and range shifting unit 12. The range adjusting unit 73 adjusts a lower limit value of a partial area, the lower limit value being transmitted from the range pointing unit 51, and transmits the adjusted lower limit value to the range shifting unit 12. In operations before the point of putting the system ready for execution of detection of the state of the facility, the range adjusting unit 73 transmits the lower limit value of the partial area, the lower limit value being transmitted from the range pointing unit 51, to the range shifting unit 12, without adjusting the lower limit value, i.e., leaving it as it is.

This embodiment provides a method of dealing with a gain change that arises at the AFE unit 72 after execution of detection of the state of the facility is started. An analog element making up the AFE unit 72, such as the amplifier, the filter, and the A/D converter, undergoes a gain change resulting from fluctuations in temperature, source voltage, etc. In proportion to this gain change, the amplitude of the digital sensor time-series signal changes. Therefore, in proportion to the gain change, the value of each element of a spectrum intensity vector outputted from the spectrum intensity conversion unit 11 (that is, the value of a frequency spectrum intensity at each frequency position) changes uniformly as well.

The range adjusting unit 73 has a role of absorbing the influence of a change in the spectrum intensity vector. Specifically, when the gain of the AFE unit 72 increases and consequently the value of each element of the spectrum intensity vector increases, the range adjusting unit 73 increases the adjusted lower limit in response to the increase of the element of the spectrum intensity vector. When the gain of the AFE unit 72 decreases and consequently the value of each element of the spectrum intensity vector decreases, the range adjusting unit 73 decreases the adjusted lower limit in response to the decrease of the element of the spectrum intensity vector.

To monitor gain changes at the AFE unit 72, the selecting unit 71 periodically selects the pilot signal. The pilot signal is, for example, a signal with a known single frequency that lies within the passband of the filter in the AFE unit 72. Similarly to the analog signal from the sensor, the pilot signal receives the influence of a gain change at the AFE unit 72 and then is converted into a frequency spectrum intensity value by the spectrum intensity conversion unit 11. The frequency spectrum intensity value is inputted to the range adjusting unit 73, which estimates a gain change at the AFE unit 72, based on a change in the inputted frequency spectrum intensity value. Further, based on the estimation result, the range adjusting unit 73 determines the adjusted lower limit in the above-described manner, and transmit it to range shifting unit 12.

The range shifting unit 12 pays attention to the partial area corresponding to the determined adjusted lower limit value, and generates a spectrum intensity vector expressed in low bits. As a result, a change reflected in the spectrum intensity vector expressed in low bits (e.g., 8 bits) turns out to be the minimum. Therefore, a change in a pseudo image generated by the pseudo image generation unit 13 too becomes the minimum. Hence a drop in classification accuracy at the image recognition AI unit 14 is minimized.

When a plurality of sensors are provided, the selecting unit 71 sequentially selects respective analog signals from the sensors and supplies the selected analog signals to the AFE unit 72. In this process, the pilot signal is periodically selected in the above-described manner.

Respective operations of the entire blocks in FIG. 7 or respective operations of blocks including the spectrum intensity conversion unit 11 and other units to follow (that is, digital circuit blocks) may be carried out on the same edge device. It may also possible that the operation in the execution period is carried out on the edge device while the operation in the learning period is carried out on a different device with higher computation ability (e.g., an external computer like a server). In such a case, respective operations of blocks including the spectrum intensity conversion unit 11 and other units to follow, the operations being shown in FIG. 7, are carried out on the different device while respective operations of the spectrum intensity conversion unit 11, the range shifting unit 12, the pseudo image generation unit 13, and the image recognition AI unit 14, and the range adjusting unit 73 are carried out on the edge device. The lower limit value of the optimal partial area and the parameter, such as the final weight, which are obtained through the operations on the different device in the learning period, are transmitted to the edge device before the start of the execution period. The different device may carry out only some of the operations shown in FIG. 7.

According to this embodiment, even when the gain of the AFE unit (analog front end circuit) that processes the analog signal from the sensor changes in a time-dependent manner due to fluctuations in temperature, source voltage, etc., a drop in the accuracy of classification of the state of the facility can be minimized. This facilitates incorporating the AFE unit into the system.

### Fifth Embodiment

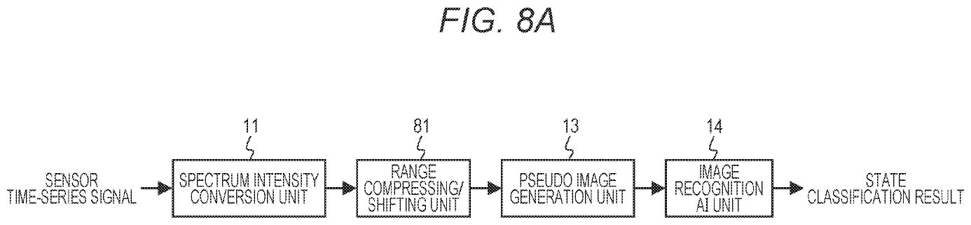

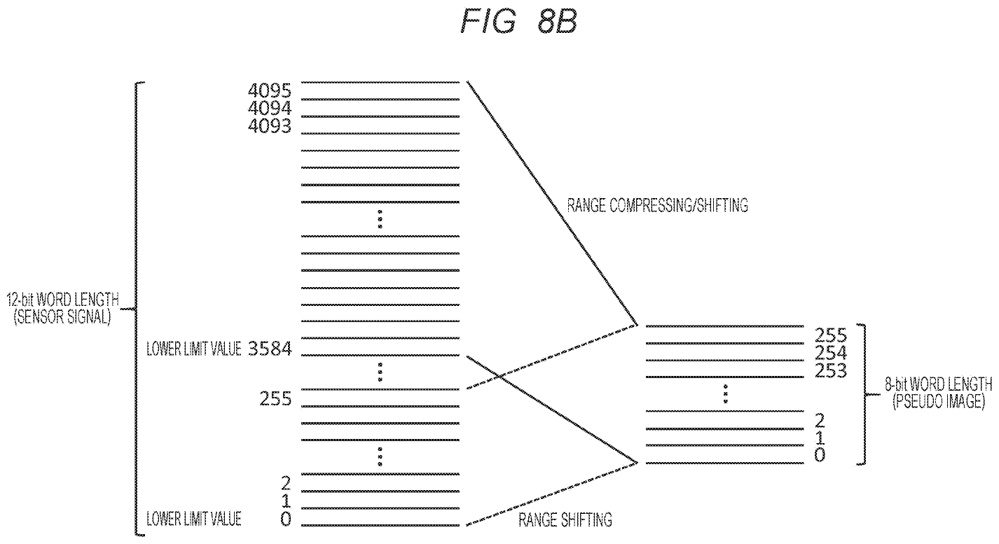

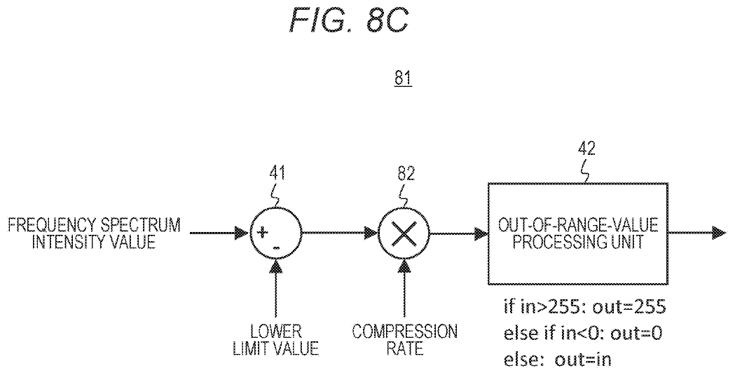

A fifth embodiment of the present invention will be described with reference to FIG. 8. It should be noted that description of the same content as already described above may be omitted. The fifth embodiment provides a method of reducing the total number of partial areas. Reducing the total number of partial areas shortens a time required for search for an optimal partial area in the second embodiment and third embodiment. In this embodiment, to reduce the total number of partial areas, the range shifting unit 12 is replaced with a range compressing/shifting unit 81.

As shown in FIG. 8A, a sensor time-series signal is sequentially processed by the spectrum intensity conversion unit 11, the range compressing/shifting unit 81, the pseudo image generation unit 13, and the image recognition AI unit 14. The range compressing/shifting unit 81 basically operates in the same manner as the range shifting unit 12 operates, except that for a partial area on an upper part, the range compressing/shifting unit 81 takes an expression range wider than the range of the expression word length of the pseudo image (8 bits in FIG. 8B). For example, in FIG. 8B, the expression range of the partial area at the uppermost part is set to 512 (3584 to 4095), which is two times 256 (0 to 255) that is the expression range of the pseudo image. For this reason, the partial area at the uppermost part requires range compression at a compression ratio of ½, in addition to range shifting. As a result, when frequency spectrum intensity values of a sensor signal are 4094 and 4095, these values are converted into 255 as the corresponding pixel value of a pseudo image. When frequency spectrum intensity values are 4092 and 4093, the corresponding pixel value of the pseudo image is 254. In the same process, when frequency spectrum intensity values are 3584 and 3585, the corresponding pixel value of the pseudo image is 0. In this manner, because two different frequency spectrum intensity values are converted into the same pixel value, a rounding error arises.

Meanwhile, as shown in FIG. 8B, the partial area at the lowermost part is given the expression range of 0 to 255 that is equal to the expression range of the pseudo image. In this case, range compression is unnecessary. In this embodiment, the total number of partial areas can be reduced by giving other partial areas at upper parts wider expression ranges. This approach, however, entails a disadvantage that a rounding error arises when a partial area at an upper part is converted into the pseudo image. However, in this case different from the case of FIG. 3B, it is unnecessary to pack the whole area of frequency spectrum intensities of the sensor signal into the expression range of the pseudo image. Therefore, range compression is minor one, so is the rounding error. Besides, because frequency spectrum components present in a partial area at an upper part have high intensities, an intensity change in this partial area caused by a change in the state of the facility is assumed to be large. It is therefore assumed that the influence of a minor rounding error ends up in little.

A configuration of the range compressing/shifting unit 81 is shown in FIG. 8C. To allow the above operation, the range compressing/shifting unit 81 further includes a multiplier 82 that multiplies incoming data by a compression rate, the multiplier 82 being disposed at a rear stage to the subtractor 41, in addition to the constituent elements of the range shifting unit 12. Specifically, the subtractor 41 subtracts a lower limit value of a partial area paid attention to, from a frequency spectrum intensity value, and then the multiplier 82 multiplies the frequency spectrum intensity value by the compression rate. Subsequently, in the same manner as in the first example, the out-of-range-value processing unit 42 processes a frequency spectrum intensity value outside the partial area paid attention to.

For example, in the example of FIG. 8B, when attention is paid to the partial area at the uppermost part, the lower limit value is set to 3584 as the compression ratio is set to ½, the above subtraction and multiplication are performed, and the multiplication result is rounded down to an integer value. When attention is paid to the partial area at the lowermost part, the lower limit value is set to 0 as the compression rate is set to 1. Other partial areas are also processed in a similar manner.

In this embodiment, the expression range of the partial area at the upper part is set two times the expression range of the pseudo image. However, to further reduce the total number of partial areas, a more wider range may be given to the partial area. In addition, the expression range of each partial area may be increased step by step as the partial area approaches the uppermost part.

As described above, according to this embodiment, by reducing the total number of partial areas, the time required for search for the optimal partial area in the second embodiment and third embodiment can be shortened.

### Sixth Embodiment

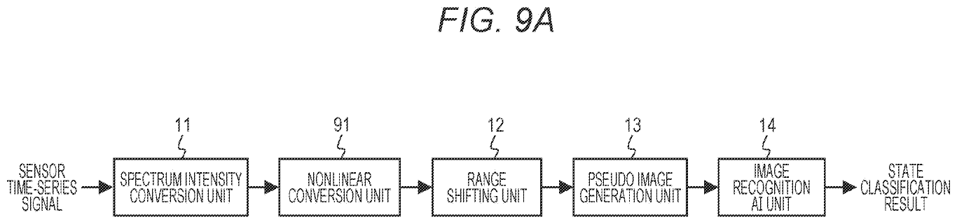

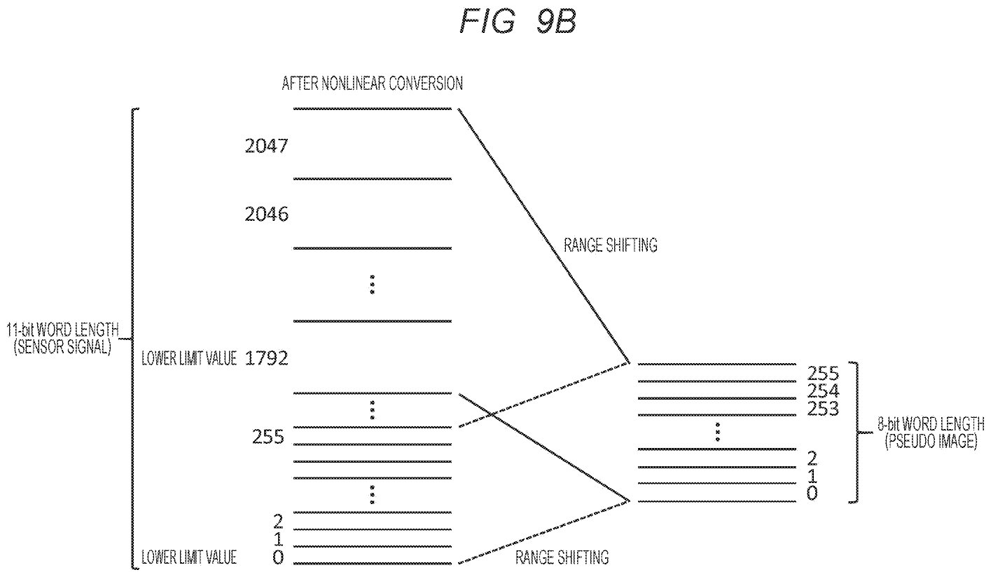

A sixth embodiment of the present invention will be described with reference to FIG. 9. It should be noted that description of the same content as already described above may be omitted. The sixth embodiment reduces the total number of partial areas, as the fifth embodiment does, thus shortening a time required for search for an optimal partial area. In this embodiment, to reduce the total number of partial areas, a nonlinear conversion unit 91 is disposed at a front stage to the range shifting unit 12.

As shown in FIG. 9A, a sensor time-series signal is sequentially processed by the spectrum intensity conversion unit 11, the nonlinear conversion unit 91, the range shifting unit 12, the pseudo image generation unit 13, and the image recognition AI unit 14. The nonlinear conversion unit 91 performs nonlinear conversion of the value of each element of each spectrum intensity vector outputted from the spectrum intensity conversion unit 11. Specifically, the nonlinear conversion is logarithmic conversion or the like by which a larger value is compressed at a higher compression rate. For example, frequency spectrum intensities of a sensor signal that are originally expressed in 12 bits (4096 values) can be expressed in 11 bits (2048 values), as indicated in FIG. 9B. As a result of the above nonlinear conversion, as shown in FIG. 9B, expression accuracy becomes lower (rougher expression) as it approaches the uppermost part, and becomes closer to the original expression accuracy as it approaches the lowermost part. Because frequency spectrum components present in a partial area at an upper part have high intensities, an intensity change in this partial area caused by a change in the state of the facility is assumed to be large. It is therefore expected that lower expression accuracy at upper parts is tolerated.

The range shifting unit 12 operates in the same manner as in the first embodiment. Specifically, the range shifting unit 12 pays attentions to a partial area of the same size as the expression range of the pseudo image (0 to 255 in FIG. 9B), and carries out word length conversion of frequency spectrum intensities subjected to the above nonlinear conversion. In FIG. 9B, the expression range of the partial area at the uppermost part is 1792 to 2047. The expression range of the partial area at the lowermost part is 0 to 255. Each partial area paid attention to is subjected to word length conversion into the expression range of the pseudo image (0 to 255 in FIG. 9B) through the constituent elements and operation of the range shifting unit 12 described with reference to FIG. 4B.

As described above, while the range compressing/shifting unit 81 compresses the expression range in the fifth embodiment, the nonlinear conversion unit 91 compresses the expression range in the sixth embodiment. The operations of both embodiments are essentially the same but are different in the form of elements that carry out the operations. In this embodiment, by reducing the total number of partial areas, the time required for search for the optimal partial are in the second embodiment and third embodiment can be shortened.

### Seventh Embodiment

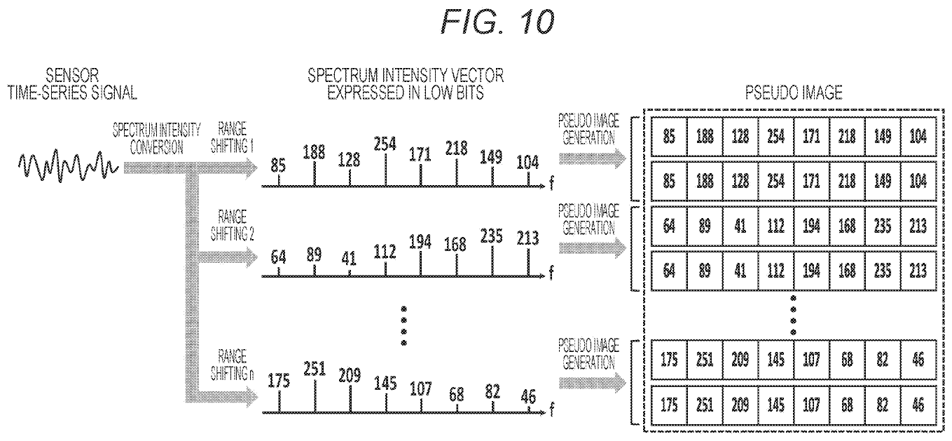

A seventh embodiment of the present invention will be described with reference to FIG. 10. It should be noted that description of the same content as already described above may be omitted. In the seventh embodiment, range shifting with attention paid to a plurality of partial areas is carried out on one sensor time-series signal, and one pseudo image reflecting the range shifting results is generated.

In an example of FIG. 10, the range shifting unit 12 pays attention to the partial area corresponding to the first lower limit value, and makes conversion into pixel values in 8-bit expression (0 to 255) in the same manner as in the first embodiment. This generates a first spectrum intensity vector expressed in low bits (8 bits). The range shifting unit 12 pays attention also to the partial area corresponding to the second lower limit value, thus generating a second spectrum intensity vector expressed in low bits (8 bits). Likewise, the range shifting unit 12 pays attention also to other partial areas, and generates spectrum intensity vectors expressed in low bits (8 bits). The pseudo image generation unit 13 generates a pseudo image, using these spectrum intensity vectors.

For example, in FIG. 10, the pseudo image generation unit 13 arranges the first spectrum intensity vector in the first row and in the second row, arranges the second spectrum intensity vector in the third row and in the fourth rows, and repeats the same pattern of vector arrangement to generate one pseudo image.

Each partial area used to generate the pseudo image is searched for in the same manner as in the second embodiment and the third embodiment. In these embodiments, one partial area that minimizes the learning error and one partial area that the maximizes the image difference amount are searched for, respectively. Similarly, in this embodiment, a plurality of partial areas that make the learning error smaller or a plurality of partial areas that make the image difference amount larger are searched for, and the retrieved partial areas are used for generation of the pseudo image.

Before execution of classification of the state of the facility, a pseudo image as shown in FIG. 10 is generated using a sensor time-series signal for training, and the image recognition AI unit 14 is subjected to a learning process using annotation data (correct answer state) corresponding to the pseudo image. The image recognition AI unit 14 may be a convolution neural network or a neural network different from the convolutional neural network, or may use a machine learning algorithm different from an algorithm adopted by the neural network.

According to this embodiment, one pseudo image can be generated using a plurality of partial areas of a sensor signal that is promising for classification of the state of the facility. This allows detection of a state change that may be overlooked by a pseudo image generated out of a single partial area.

### Eighth Embodiment

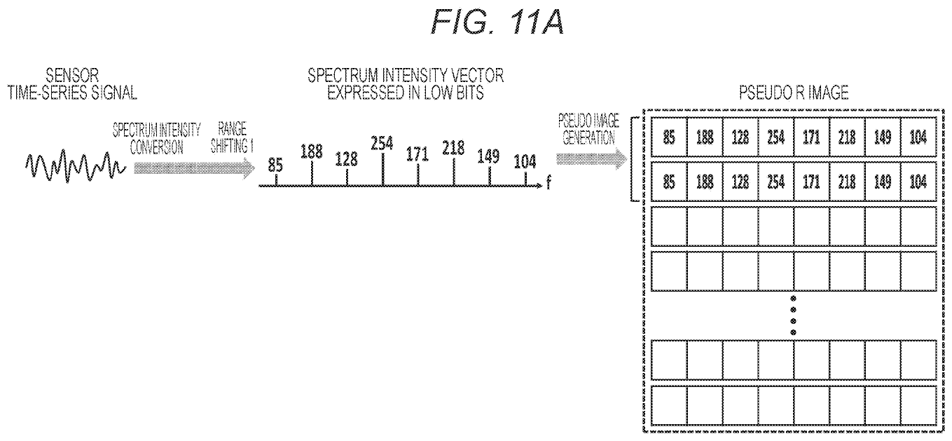

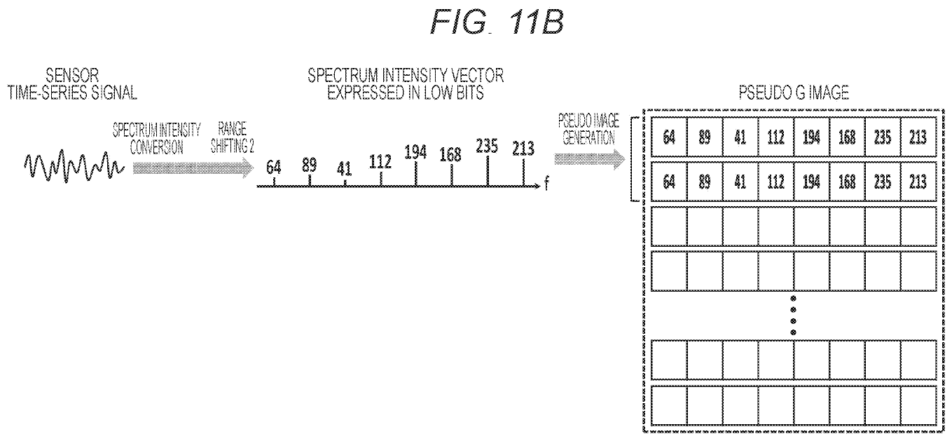

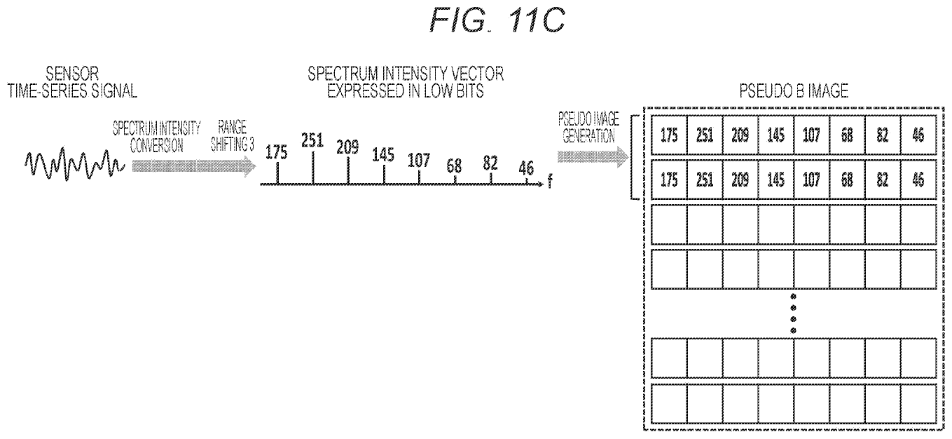

An eighth embodiment of the present invention will be described with reference to FIGS. 11A to 11C. It should be noted that description of the same content as already described above may be omitted. In the eighth embodiment, range shifting with attention paid to a plurality of partial areas is carried out on one sensor time-series signal, and a set of channels of pseudo images (e.g., R image, G image, and B image) reflecting the range shifting results are generated.

The range shifting unit 12 pays attention to the partial area corresponding to the first lower limit value, and makes conversion into pixel values in 8-bit expression (0 to 255) in the same manner as in the first embodiment. This generates a first spectrum intensity vector expressed in low bits (8 bits). The range shifting unit 12 pays attention also to the partial area corresponding to the second lower limit value, thus generating a second spectrum intensity vector expressed in low bits (8 bits). Likewise, the range shifting unit 12 pays attention also to a partial area corresponding to a third lower limit value, thus generating a third spectrum intensity vector expressed in low bits (8 bits). The pseudo image generation unit 13 generates a pseudo image, using these spectrum intensity vectors.

For example, as shown in FIG. 11A, the pseudo image generation unit 13 arranges the first spectrum intensity vector in the first row and in the second row to generate a pseudo R image. As shown in FIG. 11B, the pseudo image generation unit 13 arranges the second spectrum intensity vector in the first row and in the second row to generate a pseudo G image. As shown in FIG. 11C, the pseudo image generation unit 13 arranges the third spectrum intensity vector in the first row and in the second row to generate a pseudo B image. The same process is carried out on other sensor time-series signals to reflect range shifting results in the remaining areas of pseudo images other than the pseudo R, G, and B images.

Each partial area used to generate the pseudo image is searched for in the same manner as in the seventh embodiment. In the same manner as in the seventh embodiment, before execution of classification of the state of the facility, pseudo images as shown in FIG. 11A to 11C are generated using sensor time-series signals for training, and the image recognition AI unit 14 is subjected to a learning process using annotation data (correct answer state) corresponding to the pseudo images. The image recognition AI unit 14 may be a convolution neural network or a neural network different from the convolutional neural network, or may use a machine learning algorithm different from an algorithm adopted by the neural network.

According to this embodiment, a plurality of channels of pseudo images can be generated using a plurality of partial areas of sensor signals that are promising for classification of the state of the facility. This allows detection of a state change that may be overlooked by a pseudo image generated out of a single partial area.

In the above description, the case where range shifting is carried out by applying the same lower limit value to data from different sensors has been described. In this case, the same lower limit value is selected uniformly by the methods described in the second embodiment and third embodiment so that a proper partial area of sensor data that offers high state detection sensitivity is included. Range shifting may be carried out by applying different lower limit values to data from different sensors, respectively. In such a case, in the second embodiment and the third embodiment, the optimum lower limit value is searched for and is determined as the lower limit value for data from each sensor is independently changed. This case takes a longer searching time, but, because the optimum partial area can be selected for data from all sensors, state detection with higher accuracy is possible. In the seventh embodiment in which one sensor time-series signal is processed, the same lower limit value is selected uniformly by the methods described in the second embodiment and third embodiment so that a proper partial area offering high state detection sensitivity is included. Based on the same point of view, the optimum lower limit values may be searched for and determined as the lower limit values for data from a plurality of sensor are independently changed, respectively.

### Hardware Configuration

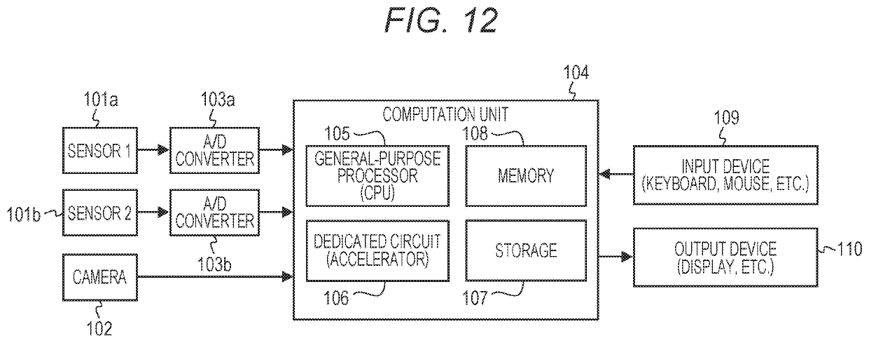

An example of a hardware configuration of the state detection system will be described with reference to FIG. 12. The state detection system shown in FIG. 12 includes a plurality of sensors (101a, 101b), a camera 102, a plurality of A/D converters (103a, 103b), a computation unit, an input device 109, and an output device 110. It should be noted that this hardware configuration is an example and may be changed when necessary.

As described above, to monitor the state of the facility, the sensors are disposed on the facility or in the vicinity of the facility and detect a given physical quantity. While two sensors (101a, 101b) are disposed in this example, three or more sensors may be disposed. In another case, a single sensor may be disposed. Like the sensor, the camera 102 is disposed to monitor the state of the facility, taking an image of the facility. The A/D converters (103a, 103b) are used to convert analog output from the sensors into digital signals. When the sensors (101a, 101b) output digital signals, the A/D converters (103a, 103b) may be dispensed with.

The computation unit will then be described. The computation unit carries out computation processes based on input data, performing the above-described spectrum intensity conversion, range shifting, pseudo image generation, image analysis, etc. In this example, the computation unit includes a general-purpose processor 105 and a dedicated circuit 106, as constituent elements (processing device 104) mainly responsible for data processing.

In this example, the general-purpose processor 105 is a central processing unit (CPU). The general-purpose processor 105 is, however, not limited to the CPU but may be provided as, for example, a different semiconductor device. The dedicated circuit 106 is used as an accelerator that improves data processing. The dedicated circuit 106 can be configured into an intended form. The dedicated circuit 106 may be provided as, for example, a graphics processing unit (GPU), a field-programmable gate array (FPGA), or an application specific integrated circuit (ASIC). The configuration of the processing device 104 may be changed when necessary, proving that the processing device 104 with its configuration changed can properly execute given processes.

In this example, the computation unit includes a storage 107 and a memory 108. The storage 107 stores data, such as programs used for processing. The storage 107 may store, for example, programs used to implement the spectrum intensity conversion unit 11, the range shifting unit 12, the pseudo image generation unit 13, the image recognition AI unit 14, the range pointing unit 51, the learning unit 53, the image comparing unit 61, the range adjusting unit 73, the range compressing/shifting unit 81, and the nonlinear conversion unit 91. The holding unit 52 can be provided using a proper storage device, such as the storage 107. The storage 107 may store, for example, data (weight, model, etc.) used for image analysis. The storage 107 may further store incoming data from the sensors (101a, 101b) or the camera 82, data on a generated pseudo image, and the like.

In addition, the storage 107 may include a training data storage unit that is a storage area for storing training data.

The storage 107 may be composed of, for example, a hard disk drive (HDD). The memory 108 is composed of, for example, a dynamic random access memory (DRAM). Based on a program or data loaded onto the memory 108, the processing device 104 executes given processes (spectrum intensity conversion, range shifting, pseudo image generation, image analysis, etc.).

The input device 109 is used by a user who makes various settings for system operations on the input device 109, and is composed of a keyboard, a mouse, a touch panel, and the like that are properly adopted. The output device 110 is used to display facility state classification results and the user's input details, and is composed of a display or the like that is properly adopted.

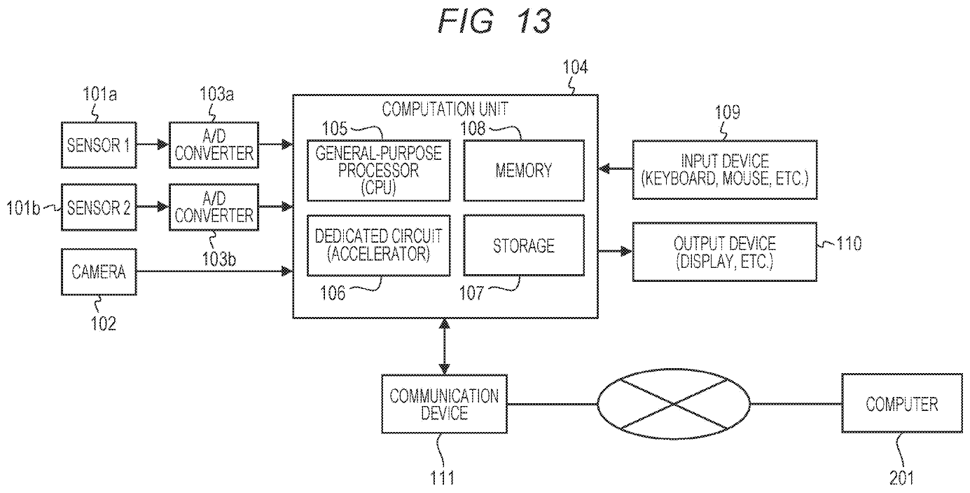

An example of a hardware configuration of the state detection system, the hardware configuration being different from the hardware configuration of FIG. 12, will then be described with reference to FIG. 13. It should be noted that description of the same content as already described above may be omitted.

The state detection system of FIG. 13 is different from the state detection system of FIG. 12 in that the state detection system of FIG. 13 includes a communication device 111 and is capable of communicating with an external computer 201. In this example, the external computer 201 having large computation resources executes a process involving a greater volume of computations, such as a learning process, and the state detection system acquires data on process results.

The communication device 111 is an interface for communication. Through the communication device 111, the state detection system can transmit and receive data to and from the external computer 201. The external computer 201, for example, may be located on the premises or may be put on a cloud system. Wired communication or wireless communication may be adopted.

Having the configuration of FIG. 13, for example, the state detection system may transmit data used for training a model or a machine learning algorithm used for image recognition, to the external computer 201 through the communication device 111. Through the communication device 111, the state detection system may acquire trained parameters of the model or the machine learning algorithm, the parameters being calculated by the external computer 201, through the communication device 111. The external computer 201 executes a learning process for each partial area, as described with reference to FIG. 5B. The state detection system may also acquire values for paying attention to a partial area in execution of state detection.

The state detection system, for example, may transmit a pseudo image indicating a different state of the facility, to the external computer 201 through the communication device 111. Then, through the communication device 111, the state detection system may acquire trained parameters in an area that maximizes an image difference amount, the parameters being calculated by the external computer 201. As described with reference to FIG. 6, the external computer 201 retrieves a partial area that maximizes an image difference amount, from a pseudo image indicating a different state of the facility, and executes a learning process on the partial area. The state detection system may also acquire values for paying attention to a partial area in execution of state detection.

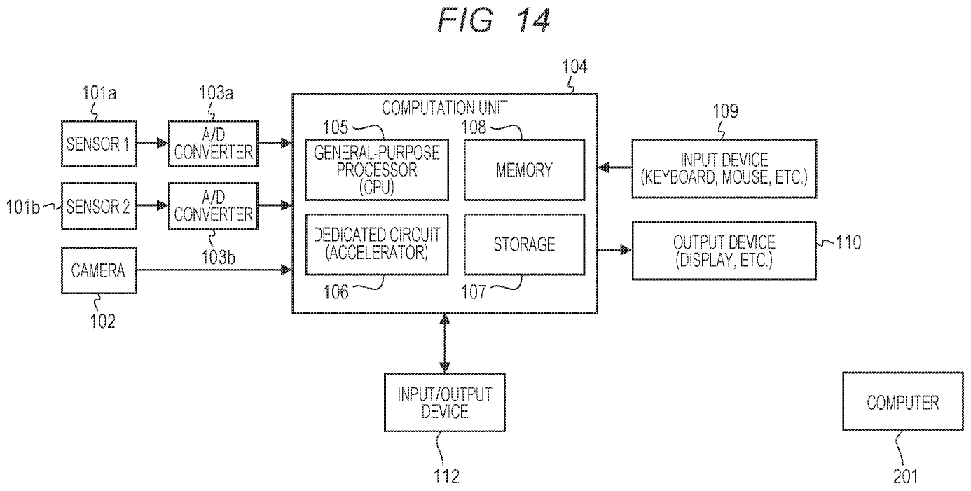

An example of a hardware configuration of the state detection system, the hardware configuration being different from the hardware configurations of FIGS. 12 and 13, will then be described with reference to FIG. 14. It should be noted that description of the same content as already described above may be omitted. In FIG. 14, the state detection system includes an input/output device 112 to which a portable storage device is connected, and outputs/receives data to/from the storage device, such as a USB memory, via the input/output device 112.

In this configuration, the user may connect the storage device to the external computer 201, which storage device is connected to the input/output device 112 and stores data for training a model or a machine learning algorithm used for image recognition, the data being supplied from the state detection system, and the external computer 201 may acquire the data from the storage device. The external computer 201 may store trained parameters of the model or the machine learning algorithm, the trained parameters being calculated, in the connected storage device, the user may connect the storage device to the input/output device 112 of the state detection system, and the state detection system may acquire the trained parameters from the storage device. The external computer 201 executes a learning process for each partial area, as described with reference to FIG. 5B. The external computer 201 may store a value for paying attention to a partial area in execution of state detection, in the storage device, and the state detection system may acquire the value from the storage device, together with trained parameters.

For example, the user may connect the storage device to the external computer 201, which storage device is connected to the input/output device 112 and stores data on a pseudo image indicating a different state of the facility, the data being supplied from the state detection system, the data being supplied from the state detection system, and the external computer 201 may acquire the data from the storage device. The external computer 201 may store trained parameters in an area that maximizes an image difference amount, the parameters being calculated, in the connected storage device, the user may connect the storage device to the input/output device 112 of the state detection system, and the state detection system may acquire the trained parameters from the storage device. As described with reference to FIG. 6, the external computer 201 retrieves a partial area that maximizes an image difference amount, from a pseudo image indicating a different state of the facility, and executes a learning process on the partial area. The external computer 201 may store a value for paying attention to a partial area in execution of state detection, in the storage device, and the state detection system may acquire the value from the storage device, together with trained parameters.

The embodiments of the present invention have been described in detail above. The present invention, however, is not limited to the above embodiments, and allows various modifications including a design change on condition that such modifications do not depart from the spirit of the present invention described in the claims. For example, the above embodiments have been described in detail for easy understanding of the present invention, and are not necessarily limited to an embodiment including all constituent elements described above. Some constituent elements of a certain embodiment may be replaced with constituent elements of another embodiment, and a constituent element of another embodiment may be added to a constituent element of a certain embodiment. In addition, some of constituent elements of each embodiment may be deleted therefrom or add to or replaced with constituent elements of another embodiment. Unless otherwise specified, each constituent element may take a single form and a plural form as well without being limited to one of them.

Respective operations of the range pointing unit 51, the learning unit 53, the image comparing unit 61, the range adjusting unit 73, the range compressing/shifting unit 81, and the nonlinear conversion unit 91 may be executed using an accelerator (dedicated hardware) or may be executed in the form of software processing using a general-purpose processor, such as a CPU. An internal memory (SRAM, etc.) built in an accelerator chip or a CPU chip may be used or an external memory (DRAM, etc.) may also be used. The holding unit 52 may be provided by using a memory.

As described above, a program used for processing may be stored in the storage device (storage 107) of the state detection system. A program used for a process executed by the state detection system, however, may be stored in, for example, the storage device connected to the state detection system via the input/output device 112.

What is claimed is:

1. A state detection system comprising a computation unit that acquires data detected by a sensor,
wherein the computation unit includes a processing device that executes data processing,
the processing device converts data of a digitized time-series signal from the sensor, into data on frequency spectrum intensity;
converts a partial area in an overall area in which values of the data on frequency spectrum intensity are distributed, into data expressed in low bits;
generates a pseudo image, based on the data expressed in low bits; and
classifies the pseudo image, based on image recognition, and outputs a result of classification of a state of a facility.

2. The state detection system according to claim 1, wherein
the processing device carries out image recognition using a model on a neural network or using a machine learning algorithm.

3. The state detection system according to claim 1, wherein
the processing device carries out conversion from a value of the data on frequency spectrum intensity into the data expressed in low bits, using a reference value of the partial area.

4. The state detection system according to claim 3, wherein
the processing device replaces a value outside an expression range in low bits with a preset value within the expression range in low bits, thereby obtaining the data expressed in low bits.

5. The state detection system according to claim 1, wherein
the partial area used at execution of the classification is determined based on accuracy of training of a model or a machine learning algorithm used for the image recognition.

6. The state detection system according to claim 1, wherein
the partial area used at execution of the classification is determined based on an amount of a difference between the pseudo images corresponding to different states of a facility.

7. The state detection system according to claim 3, further comprising an analog front end unit that processes a signal from the sensor,
wherein a digitized time-series signal from the sensor is obtained as a result of the analog front end unit's processing an analog signal from the sensor,
the state detection system further comprises a selecting unit that periodically selects a pilot signal with a known frequency and that outputs the pilot signal to the analog front end unit, and
the processing device adjusts the reference value, based on a frequency spectrum intensity related to the pilot signal.

8. The state detection system according to claim 1, wherein
the partial area occupying a side on which a value of data on the frequency spectrum intensity is large in the overall area is set wider than an expression range in low-bits.

9. The state detection system according to claim 1, wherein
the processing device makes conversion into the data expressed in low bits, based on data obtained by nonlinear conversion of data on the frequency spectrum intensity.

10. The state detection system according to claim 1, wherein
the processing device makes
conversion into pieces of data expressed in low bits, based on a plurality of the partial areas, and
generates one pseudo image, based on the pieces of data expressed in low bits.

11. The state detection system according to claim 1, wherein
the processing device makes conversion into pieces of data expressed in low bits, based on a plurality of the partial areas, and generates a plurality of channels of pseudo images, based on the pieces of data expressed in low bits.

12. The state detection system according to claim 1, further comprising a communication device,
wherein the processing device acquires a trained parameter of a model or a machine learning algorithm used for the image recognition, through the communication device.

13. The state detection system according to claim 12, wherein
the processing device acquires a trained parameter of an area that minimizes a learning error in learning processes carried out respectively on the partial areas making up the overall area, through the communication device.

14. The state detection system according to claim 12, wherein
the processing device acquires a trained parameter of the partial area that maximizes an amount of a difference between the pseudo images corresponding to different states of a facility, through the communication device.

15. The state detection system according to claim 1, further comprising an input/output device to which a portable storage device is connected and which exchange data with the storage device connected to the processing device,
wherein the processing device acquires a trained parameter of a model or a machine learning algorithm used for the image recognition, the trained parameter being calculated by an external computer and stored in the storage device, through the input/output device.

16. The state detection system according to claim 15, wherein
the processing device acquires a trained parameter of an area that minimizes a learning error among the partial areas making up the overall area, through the input/output device.

17. The state detection system according to claim 15, wherein
the processing device acquires a trained parameter of the partial area that maximizes an amount of a difference between the pseudo images corresponding to different states of a facility, through the input/output device.

18. A state detection method executed by using a processing device, the method comprising the steps of, by the processing device that executes data processing:
converting data of a digitized time-series signal from a sensor, into data on frequency spectrum intensity;
converting a partial area in an overall area in which values of the data on frequency spectrum intensity are distributed, into data expressed in low bits;
generating a pseudo image, based on the data expressed in low bits; and
classifying the pseudo image, based on image recognition, and outputting a result of classification of a state of a facility.

19. A program that causes a processing device to execute the state detection method according to claim 18.

20. A storage device storing a program that a computer reads and executes to implement the state detection method according to claim 18.
